(19) United States
(12) Patent Application Publication
(10) Pub. No.: US 2008/0228566 A1
(43) Pub. Date: Sep. 18, 2008

(54) PROCESSING COUPONS WITH PAYMENTS

(75) Inventors: Charles J. Williams, Redmond, WA (US); Sergey I. Bykov, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/686,603

(22) Filed: Mar. 15, 2007

(51) Int. Cl. G06Q 30/00

(52) U.S. Cl. 705/14

(57) ABSTRACT

Systems and methods that combine coupon processing with payment processing (e.g., a credit/debit card transaction). Payment processing entities can function as the coupon clearinghouse between coupon issuers and merchants. Accordingly, processing costs can be mitigated as coupons are no longer processed separately from other tenders, (e.g., coupons can be processed same manner electronic transactions related to payments are processed, and by the same service provider.

### BACKGROUND

Today, a typical transaction, which involves coupons, would include a customer clipping the coupons at home, taking the coupons to the store, and selection of products for check out at a cashier station or point of sale (POS) terminal. Coupons are then redeemed by merchants via settlement thereof through clearing houses and submittal to coupon issuers.

In general, consumers receive coupons through a variety of channels such as: mailings, newspapers, showings on the product itself, or printed at a retail outlet. Moreover, newspapers and leaflets of coupons mailed or delivered to residences of customers still remains the most common channel for delivering coupons to customers. Such printed coupons are presented at the checkout station to obtain a discount on a product. The paper coupons are collected at the POS by the retailer and then sent to a clearinghouse, which in turn separates the coupons and bills respective coupon issuers for reimbursement of the retailer.

Such system has proven to cause problems for both customers and retailers. For example, customers have to manually clip desired coupons and sort them by product categories (e.g., detergents, canned foods, cereals, frozen foods, toiletries, and the like) to efficiently find products when shopping at the store. Furthermore, customers have to periodically examine their collection of coupons and discard expired ones. Moreover, retailers also have to expend considerable hours and resources to sort through coupons by manufacturer for redemption, and monitor expired coupons at the checkout station.

Typically, coupons that are collected by a retailer are passed through a clearinghouse for assortment and recount. Such clearinghouse can subsequently pay retailers cash for estimated value of the coupons, wherein a difference between the estimated and actual amount can later be credited or debited. Nevertheless, retailers are still required to monitor for expired coupons and handle coupon collection and submittal to the clearinghouse for payment.

Another problem of such paper coupon system is misredemption. For example, misredemption can occur when a consumer employs a coupon without purchasing an item associated therewith. Likewise, checkout clerks can inappropriately exploit such paper coupon system by replacing coupons with cash. Misredemption of coupons is estimated to be as high as 20%-30%.

Conventional payment processing and coupon reconciliation systems typically have a very high cost of processing per transaction due to much inefficiency including, processing payments and coupons independently and constant monitoring and interaction by operation person, for example.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject invention provides for shopping network systems and methods that combine coupon processing with payment processing (e.g., a credit/debit card transaction)—wherein payment processing entities can function as the coupon clearinghouse between coupon issuers and merchants. Accordingly, processing costs can be reduced, as coupons are no longer processed separately from other tenders, (e.g., coupons can be processed in same manner that electronic transactions related to payments are processed, and by the same service provider.) Moreover, integration of the coupon processing with payment processing can further reduce a time delay arising from settlement of the coupons, and expedite reimbursement of funds to the merchants.

In a related aspect, coupon data can initially be supplied to the merchant and subsequently forwarded to payment processing entities. Alternatively, such coupon data can be sent directly to the payment processing entities, from the consumer via an intelligent device (e.g., mobile computer, cell phone, and the like), which can be carried by a customer. From a merchant's perspective a single request can be forwarded to the processing entity, wherein such request addresses both the coupon account and payment account (e.g., credit card), for example. As such, the subject innovation can leverage existing security protocols and payment processing infrastructure, to facilitate coupon processing. Moreover, existing trust relations that have been established can be employed (e.g., established relationships between banks, merchants, and payment processing entities.)

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a business commerce network with a payment processing entity that processes both payment requests and coupon data in accordance with an aspect of the subject innovation.

FIG. 2 illustrates a further block diagram for a system that integrates payment processing with coupon processing according to a particular aspect of the subject innovation.

FIG. 3 illustrates a payment processing entity that further incorporates an error detection/correction component as part of a payment processing and payment processing according to an exemplary aspect of the subject innovation.

FIG. 4 illustrates a related methodology of processing coupons and payments via a processing unit in accordance with an aspect of the subject innovation.

FIG. 5 illustrates a further methodology of settling coupons according to a further aspect of the subject innovation.

FIG. 6 illustrates a payment processing and coupon clearance workflow in accordance with an aspect of the subject invention.

FIG. 7 illustrates exemplary packet formats for coupon files associated with an electronic coupon in accordance with an aspect of the subject innovation.

FIG. 8 illustrates a block diagram of a shopping network system that employs an online storage component, and combines coupon processing with payment processing.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

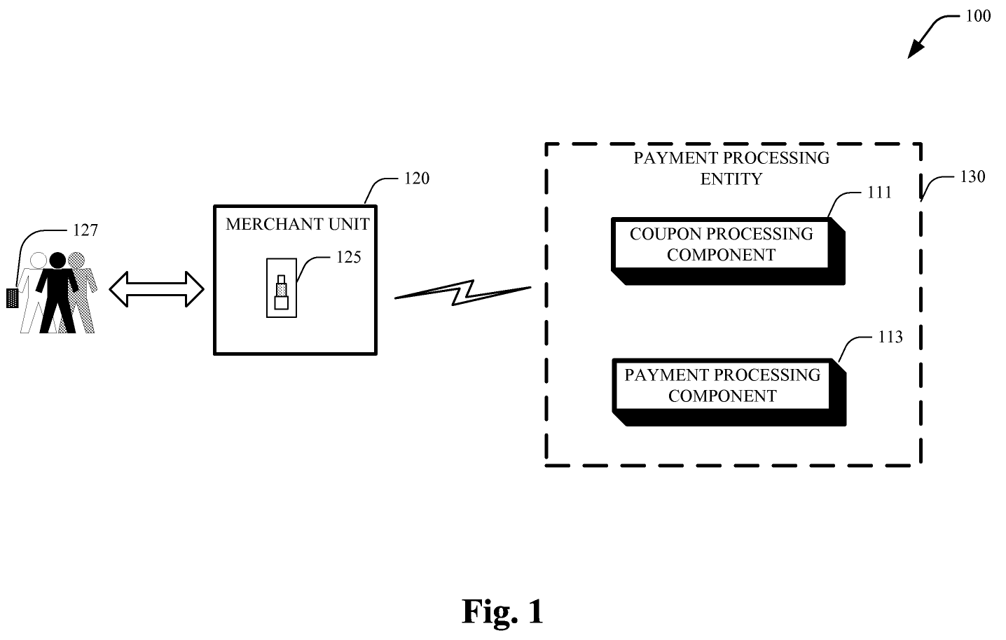

FIG. 1 illustrates a block diagram of a shopping network system 100 that combine coupon processing with payment processing (e.g., a credit/debit card transaction), wherein payment processing entities can function as the coupon ‘clearing house’ between coupon issuers and merchants. Such a network can be implemented in connection with a commercial transaction (e.g., for a retail, electronic web purchases, grocery stores, and the like) and can include proprietary network transaction data flows on payment gateways, which take payment requests from merchant and route such request to proper processing entities, for example.

In general, payment processing component 113 can settle charges with payment providers (e.g., Visa® and MasterCard®), as part of the payment processing entity 130 that integrates coupon processing with payment processing in accordance with an aspect of the subject innovation. Such payment processing entity 130 can typically serve as front end to the merchant unit 120.

For example, the merchant unit 120 can receive coupon data and payment information and send such information as a single request to payment processing entity 130. The merchant unit 120 can further include: a central host computer operatively connected to a plurality of in-store customer sale terminals that can represent point of sale (POS); a wireless local area network that includes a plurality of access points; and a wired backbone for communicating data between the central host and the customer sale terminals (not shown). The customer sale terminals 125 can receive coupon data and product data via an input component such as a scan read. The network can also include a plurality of manufacturer's servers, each corresponding to the manufacturer of a product available at the merchant's store. Each manufacturer's server can be communicatively coupled to the merchant's host via the internet, for example.

The merchant unit 120 can further accept coupon data via an intelligent device(s) 127 (e.g., mobile computer, personal digital assistant, cell phone and the like) that can be carried by the customer, for example. Such intelligent device 127 can supply identifying information, coupon data and payment information to the merchant 120, via an exchange of information therewith. The coupon data can be processed by the coupon processing component 111, wherein coupon data can be cleared the respective manufacturer for reimbursement of the merchant (e.g., retailer.) Hence, an operation of the processing component 111 integrates both operations relating to payment processing and coupon clearance.

As such, the subject innovation can leverage the existing security protocols and payment processing infrastructure, to facilitate coupon processing. Moreover, existing trust relations that have been established can be employed (e.g., established relationships between banks, merchants, and payment processing entities.)

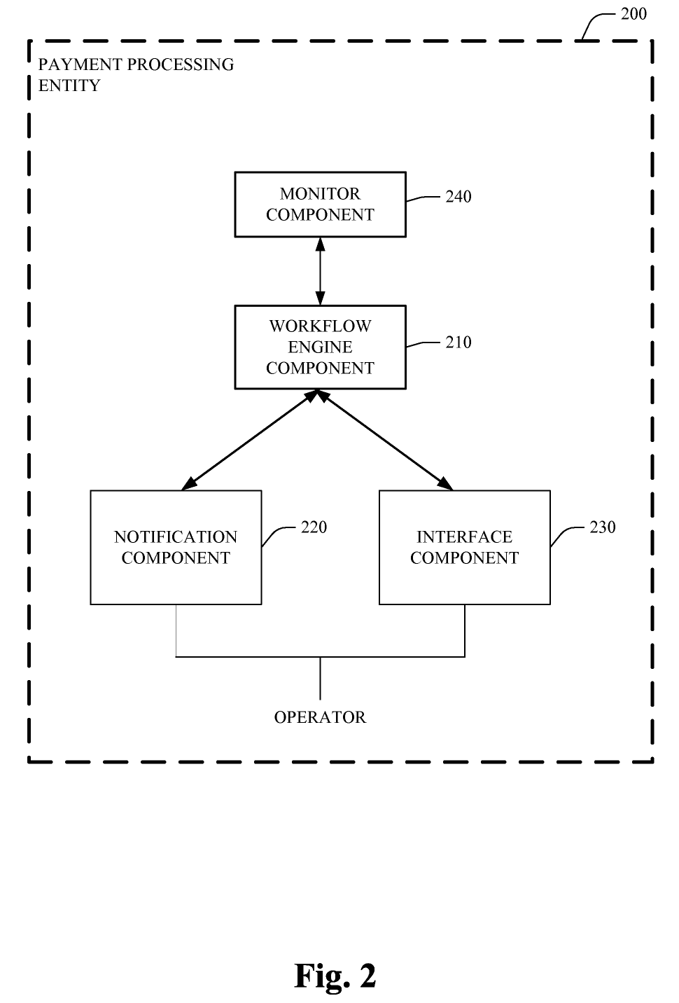

FIG. 2 illustrates a particular payment processing entity 200 that can further function as a coupon-clearing house for transactions forwarded thereto. Such forwarded transactions can include a plurality of single requests, wherein each single request combines coupon data and payment data together, according to an aspect of the subject innovation. The payment processing system 200 can further include: a workflow engine component 210, a notification component 220, an interface component 230, and a monitor component 240. The workflow engine component 210 executes and manages workflow process instances. A workflow is a sequence or series of tasks used to manage and monitor processes, such payment processing and/or coupon settlement. Accordingly, processing costs can be mitigated as coupons are no longer processed separately from other tenders, (e.g., coupons can be processed same manner electronic transactions related to payments are processed, and by the same service provider. Moreover, integration of the coupon processing with payment processing can further reduce a time delay arising from settlement of the coupons, to expedite reimbursement of funds to the merchants.

For example, a workflow instance can be instantiated for integrating processes for coupon settlement and reimbursement with third parties (e.g., banks, coupon issuers and the like). The workflow engine component 210 can execute a series of tasks provided to it via a workflow instance associated with electronic coupon processing and payment processing. Tasks associated with the workflow can include creating a file, sending a file, retrieving a file, validating a file, reconciling a file, providing notification to a user or operator, retrieving information from a user or operator, and the like. The workflow engine component 210 can further employ a queue (not shown) to execute tasks with higher priority before tasks with lower priority, wherein tasks related to processing a coupon can be performed separate, or in conjunction with tasks for processing the payment.

Furthermore, when a workflow act or task requires operator input, workflow engine component 210 interacts with the notification component 220 to notify an operator that a related input is required. Such notification can employ a context analyzer (not shown) and statistical models to infer a best communication medium upon which to provide a notification (e.g., pop-up window, email, mobile phone, office phone, personal digital assistant (PDA), pager . . . ) to customers and/or operator of the POS terminal. Upon notification, an operator can communicate with the workflow execution engine via the user interface component 230. For example, the interface component 230 can be a graphical user interface (GUI) that facilitates interaction and transfer of information.

Payment processing system 200 also includes a monitor component 240, which monitors system resources to determine whether to increase the rate of executing tasks (e.g., from a queue), decrease the rate of tasks executing, or hold the rate of task execution at the same rate. This information can then be provided to the workflow engine component to effect the execution of payment processing tasks and coupon clearing tasks.

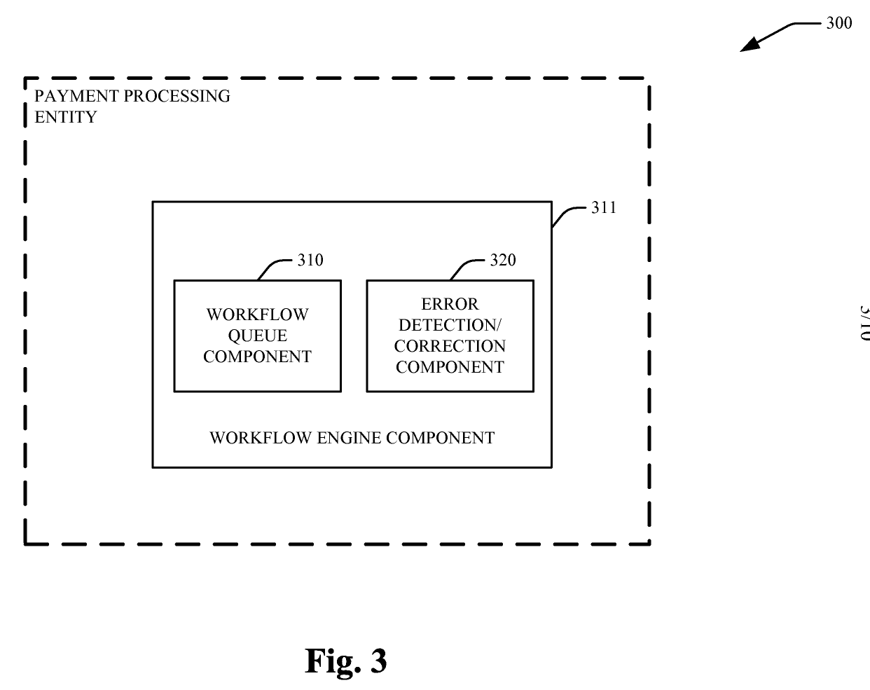

FIG. 3 illustrates a payment processing entity 300 that further incorporates an error detection/correction component 320 as part of a payment processing combined with a coupon processing according to an aspect of the subject innovation. The workflow engine component 311 includes a workflow queue component 310 and an error detection component 320. As described supra, the workflow engine component 311 orchestrates the execution of workflow tasks. To enable efficient execution of tasks related to combined processing of coupons and payments, a workflow queue component 310 can be employed, in the form of a database table, list, or stack that specifies the task execution order relative to other tasks, for example.

The workflow engine component 311 employs the workflow queue component 310 to facilitate execution of tasks in order of priority (e.g., highest priority to lowest priority). It is to be appreciated that the workflow engine component 311 can spread tasks over multiple computers having multiple processes with multiple threads and communicate via a network connection. Accordingly, increased efficiency in the execution of workflows can be accomplished by distributing workflows or workflow tasks amongst a plurality of workflow engine components 311 and/or computer systems for execution.

As illustrated, the workflow engine component 311 can further include an error detection/correction component 320 for detecting existence of error during execution of workflow tasks and facilitates easy recovery from an error resulting from among other things a system failure or a network failure. Upon the occurrence of, and detection of an error, the error detection/correction component 320 can compensate for such an error via check pointing, rollback schemes, and the like. For example, in a check pointing scheme a log file is maintained containing safe states. When problems occur, the workflow engine component 311 can restart task execution at the most recently available safe state. In a rollback scheme, effects of actions performed after the error and even before the error can be undone by applying corresponding reverse actions. It is to be appreciated that error avoidance schemes in form of error prediction and avoidance schemes can be employed by the error detection/correction component 320. For example, system stability can be analyzed by the error detection/correction component 320 using statistical methods, neural networks, experts systems and various other adaptive systems and components to predict within a particular threshold the failure of a workflow execution component or the computer system on which it is running. Subsequently, the tasks that were to be executed on the workflow engine component 311 are predicted to fail or otherwise encounter problems can be shifted to another workflow engine component 311 to avoid any problems.

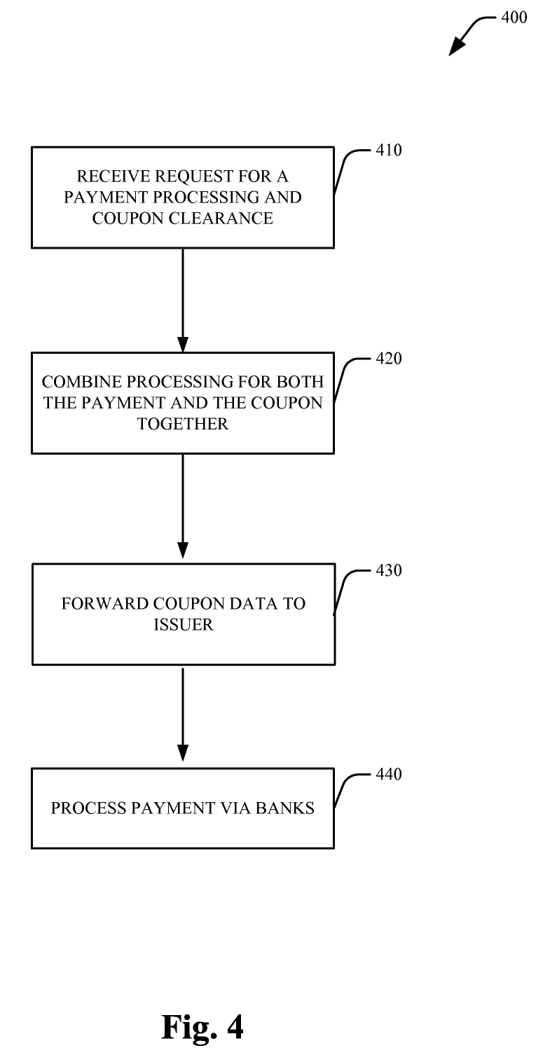

FIG. 4 illustrates a related methodology 400 of processing coupons and payments via a processing unit in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and at 410 a payment processing request and a coupon processing request is received by a processing entity that combines operation for payment processing and coupon clearance. Subsequently, and at 420 such processing entity can combine the processing for both the payment and the coupon together and as part of an integrated operation. At 430, data related to the coupon is forwarded to the coupon issuer for redemption by the merchant. Likewise, and at 440 the payment received by the processing center can be forwarded to banks for a processing thereof. Accordingly, processing costs can be mitigated as coupons are no longer processed separately from other tenders.

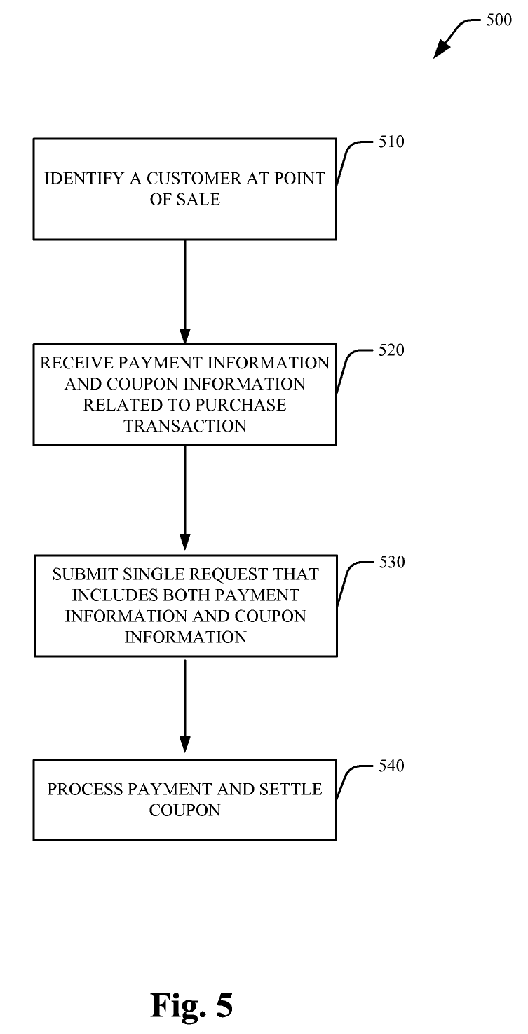

FIG. 5 illustrates a further methodology 500 of settling coupons according to a further aspect of the subject innovation. Initially and at 510 a point of sale (POS) terminal can identity a customer via a portable intelligent device (e.g., a mobile computer, a personal digital assistant, a cell phone, and the like). Next, and at 520 such POS terminal receives payment information and coupon information related to a purchase transaction. At 530, the POS can submit a single request that includes both the payment information and coupon information to a processing entity that combines service for processing of the payment and settlement of the coupon. Subsequently and at 540, the processing entity processes the payment (e.g., via submittal to a bank) and settles the coupon (e.g., submittal to the coupon issuing entity for redemption by merchant).

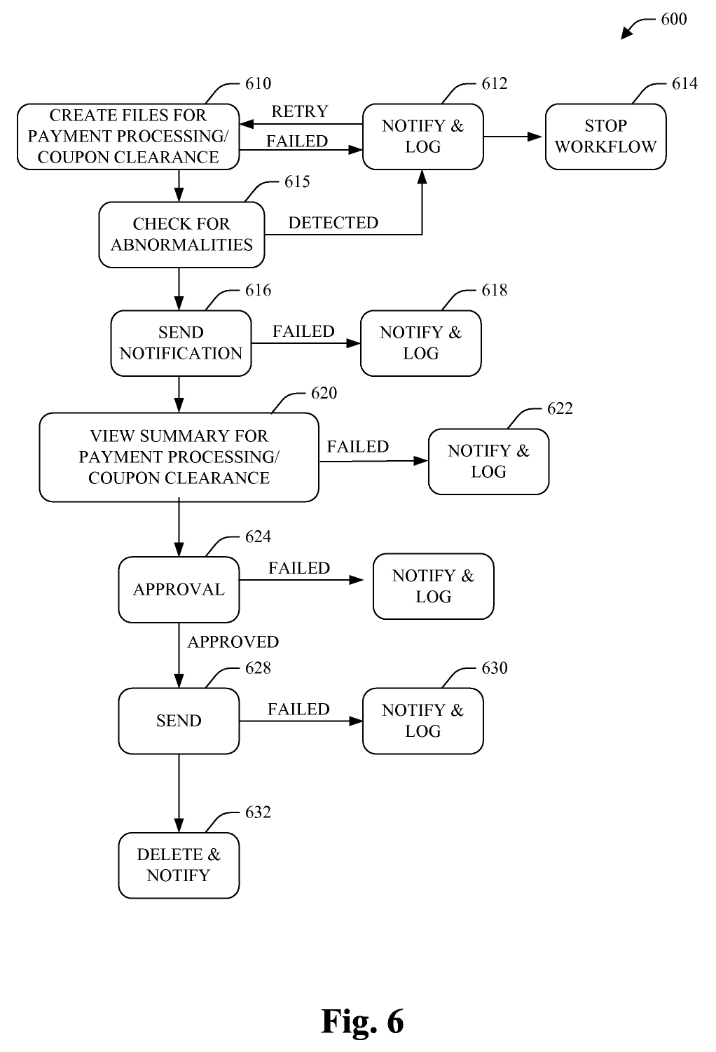

FIG. 6 illustrates a payment processing and coupon clearance workflow 600 in accordance with an aspect of the subject invention. The workflow 600 provides for creating a file(s) containing purchasing information and coupon data (e.g., for clearing and processing such coupon) obtaining approval by a human operator (e.g. at the POS), and subsequently sending out data to a payment provider. At 610, a file is created in response to a user request for purchasing an item and for coupon submission associated therewith. It is to be appreciated that coupon data can be supplied to the merchant at the POS and subsequently forwarded to payment processing entities—or alternatively, such coupon data can be sent directly to the payment processing entities, from the consumer via an intelligent device (e.g., mobile computer, cell phone, and the like.) It is to be appreciated that the payment processor can also obtain applicable coupon data directly from a consumer's coupon account.

At 610, a file can be created when a user indicates a desire to purchase a product over the Internet, for example. Alternatively, a user can set up a schedule to charge a credit card for example for a monthly service (e.g., subscription). If the file creation fails at 610, then such failure is logged (e.g., in a database) and a user or operator is notified of the failure at 612. Moreover, the workflow 600 can retry to create the files at 610 based on predetermined criteria, such as retrying a plurality of times and/or after a certain period. If after performance of such predetermined criteria the file(s) related to the payment processing and coupon data are not created, then the workflow stops at 614 and the POS operator and the consumer are notified.

If the file(s) are successfully created, a process is initiated to determine if there are any abnormalities in the created file(s) at 615. For example, artificial intelligence such as expert systems, Bayesian networks and/or neural networks can be employed to predict the content of the files based upon the input provided thereto. Accordingly, should the created file(s) vary from what is predicted then the process will proceed to 612 where the errors are logged and a notification produced. Subsequently the workflow 600 can proceed to 614 and halted.

Alternatively, and if no abnormalities are detected then a notification is sent to a point of sale operator that indicates a successful creation of file(s) at 616. The notification can take the form of a web page including information (e.g. table) about the created files and buttons to view a summary and approve created files. Other mediums of communication that employed to notify an operator can include a short message system (e.g., text messaging), and an instant message system, for example.

The process can then be suspended to wait for a response from the notified individual. If notification fails then such failure can be logged and a user or operator notified at 618. An operator (e.g., at the POS terminal can view the summary of files that are ready for approval at 620. If, however, an operator initiates viewing of the files and is not able to view the files, then the error can be logged and a notification generated at 622. After a user or operator views the files at 622, the process awaits approval of the file(s) at 624. At 628, the file can be sent to a payment provider and related coupon data forwarded to issuing units, e.g., based on a predetermined schedule.

Likewise, if it is detected that the files are not sent successfully, then at 630 the failure is logged and a user or operator is notified. Upon successful transmission of coupon data and payment data to banks and issuing entities, such files can be deleted at 632, with a notification message sent to the POS, for example.

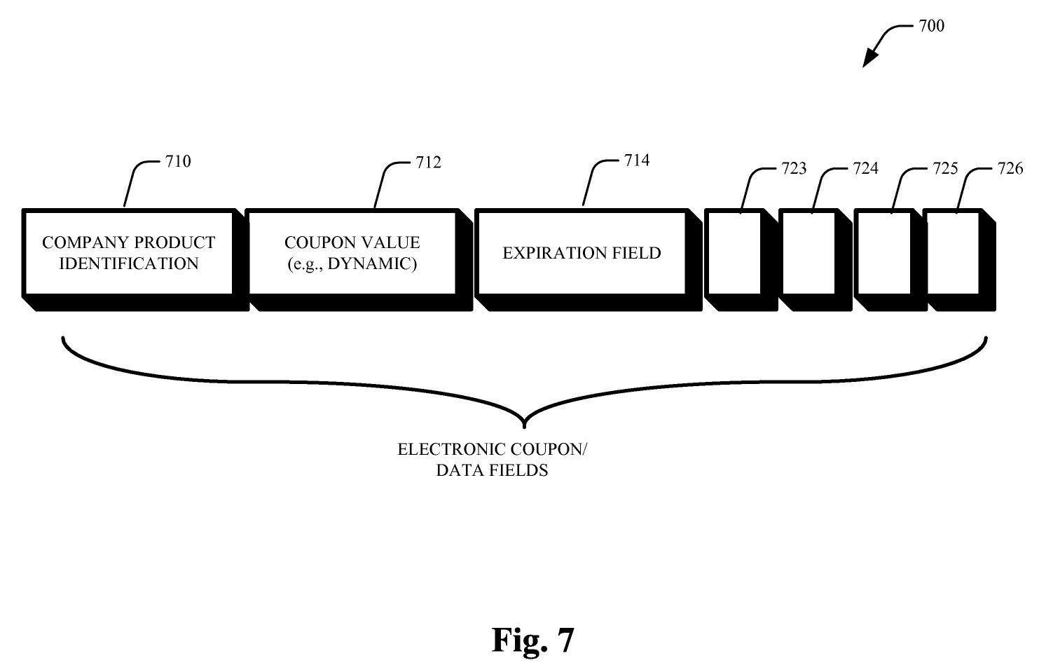

FIG. 7 illustrates an exemplary packet formats for coupon files associated with an electronic coupon in accordance with an aspect of the subject innovation. The electronic coupon can be submitted by an intelligent device carried by a customer, or can be derived from a paper coupon via a scan thereof, for example. Associated data can include shopping list/purchase files and price look up files. The coupon file packet 710 can include company product identification, and a coupon value field 712, which can include information relating to the value of the coupon 700. The field 712 can include a formula for use in the case where the coupon value is dynamic in nature. An expiration field 714 can include data relating to when the coupon 700 expires. A bitmap icon field 723 includes data that can be used to generate an icon representing the product the coupon associated therewith. A manufacturer's website field 724 includes link information to the web site of the manufacturer that issued the coupon 700. A product data field 725 includes information relating the product the coupon is associated therewith. A date used field 726 includes data relating to when the coupon was actually used by the customer.

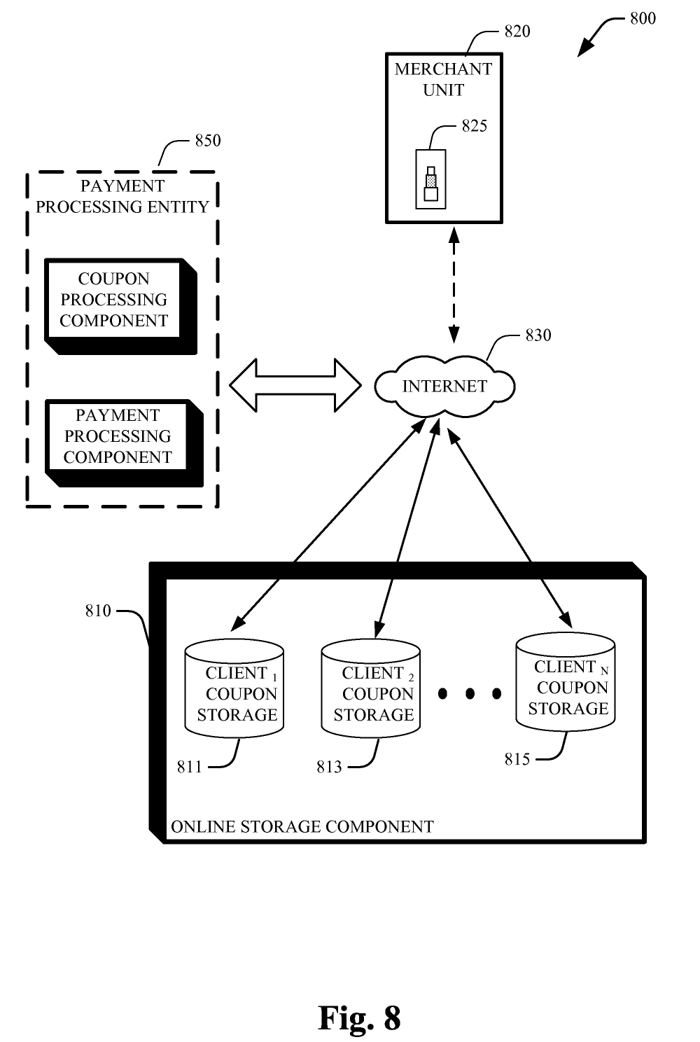

FIG. 8 illustrates a block diagram of a shopping network system 800 that employs an online storage component 810 and combines coupon processing with payment processing (e.g., a credit/debit card transaction). The payment processing entity 850 can function as the coupon ‘clearing house’ between coupon issuers and merchant units 820. Moreover, the shopping network system 800 redeem coupons via an online storage component 810 that stores coupon data for a consumer and regardless of which issuer has issued the coupon. Accordingly, such online storage medium component 810 can store coupons online in storage mediums 811, 813, 815 (1 thru N, where N is an integer) that can represent a single location for each consumer. Such online storage component 810 can operate without being tied to a particular service, and can readily provide redemption (e.g., an automatic redemption). The consumer and other retail entities (e.g., coupon issuers, merchant units 820, and the like) can populate the online storage component periodically, or in response to predetermined events (e.g., physical location of consumer, associated demographics, and the like.) In addition, the merchant terminal 825 can be part of and/or communicatively coupled to the merchant unit 820 via the internet 830.

Moreover, the online storage medium component 810 can function as a live service wherein users (e.g., consumers) can register therewith to store their coupons therein. Accordingly, the online storage component 810 can aggregate coupons collected from a plurality of channels (e.g., paper coupons, electronic coupons) therein—via submission thru the internet 830. Such service can organize collected coupons; facilitate a search thereof, and mange redemption and access to the collected coupons. During a purchase transaction, users redeem coupons that are related to the purchase via an identification process, wherein the terminal 825 (point of sale—POS) receives such coupons and can apply them to the user's shopping basket at checkout. Items in basket of the consumer can be matched with coupons stored for each respective client 811, 813, 815 and rules relating thereto (e.g., discourage using the coupons for the same identical transaction.) Additionally, the payment processing entity 850 can cross check transaction line item data (e.g., a basket) against payee's available coupons (e.g., coupon account). For example, such can occur when the payment processing entity automatically detects applicable coupons via cross checking and/or verification of items in basket against coupons available in the online storage component.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

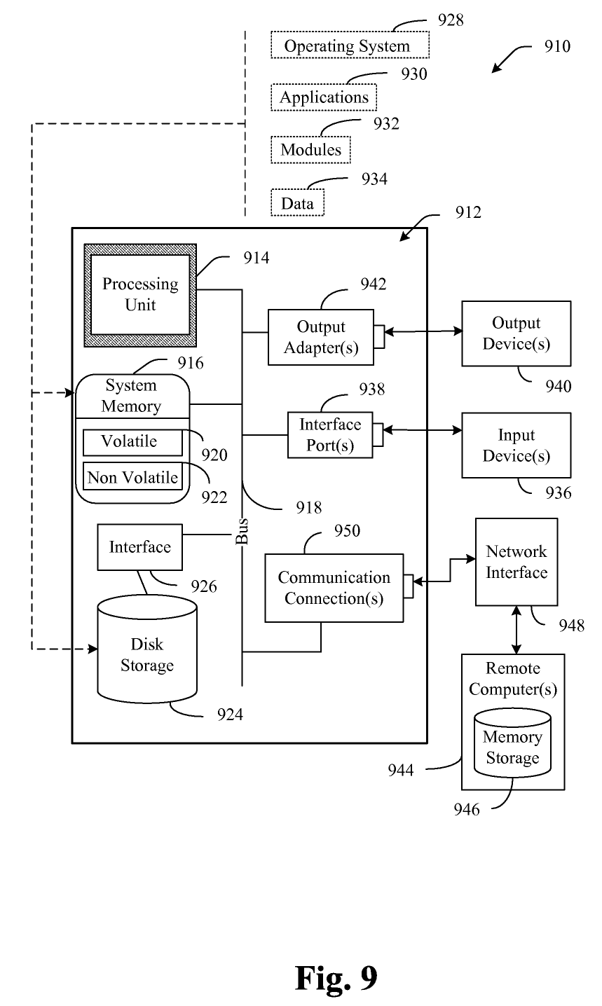

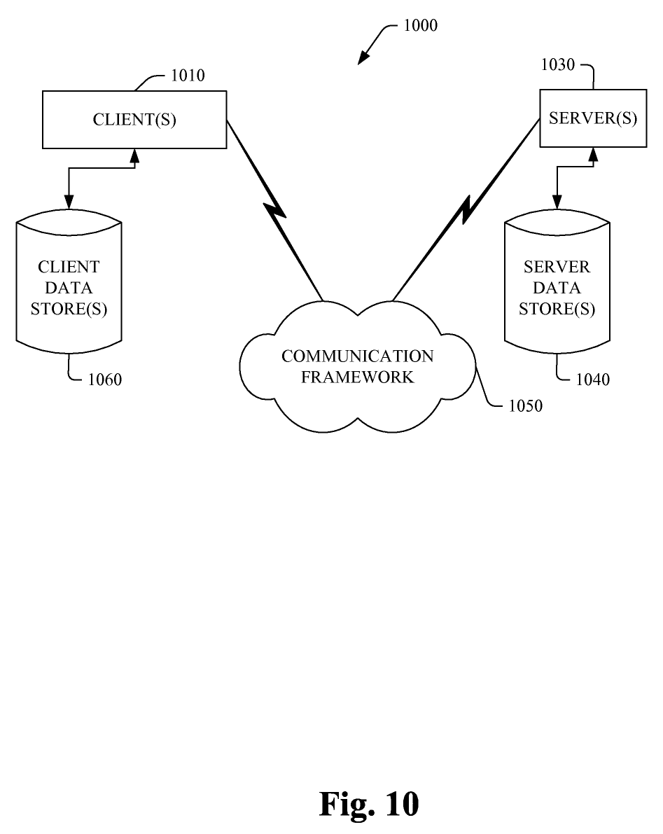

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a processing system in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a point of sale terminal that receives a payment(s) and a coupon from a customer; and
a processing entity that processes the payment and the coupon as part of an integrated processing operation.

2. The computer implemented system of claim 1 further comprising a workflow engine component that executes a workflow instance that includes a list of tasks related to processing payments and coupons.

3. The computer implemented system of claim 2, the work flow engine further comprising a queue to execute tasks according to priority.

4. The computer implemented system of claim 3 further comprising a notification component that notifies an operator for a required input.

5. The computer implemented system of claim 3 further comprising a monitor component that monitors system resources.

6. The computer implemented system of claim 3 further comprising an error detection component that detects existence of error during execution.

7. The computer implemented system of claim 4 further comprising a context analyzer that determines a communication process with the operator.

8. The computer implemented system of claim 4 further comprising a log file to restart execution of the workflow at a safe state.

9. The computer implemented system of claim 8 further comprising an interface component that facilitates interaction between the operator and the workflow engine.

10. The computer implemented system of claim 9 further comprising an online coupon storage component that stores coupons for a customer.

11. A computer implemented method comprising:
receiving a payment and a coupon for a purchase transaction by a processing entity; and
processing both the payment and clearing the coupon by the processing entity.

12. The computer implemented method of claim 11 further comprising creating a file containing purchase data and coupon data for the purchase.

13. The computer implemented method of claim 11 further comprising forwarding the payment to a bank.

14. The computer implemented method of claim 11 further comprising forwarding the coupon to an issuing entity of the coupon.

15. The computer implemented method of claim 11 further comprising forwarding the coupon from a customer to the processing unity.

16. The computer implemented method of claim 11 further comprising forwarding the coupon from a point of service terminal to the processing entity.

17. The computer implemented method of claim 11 further comprising detecting applicable coupons by cross checking transaction line item data against payee's coupon account.

18. The computer implemented method of claim 11 further comprising forwarding a single request to the processing entity, the single request for processing both payment data and coupon data.

19. The computer implemented method of claim 11 further comprising monitoring resources of the processing entity.

20. A computer implemented system comprising:
means for receiving a payment(s) and a coupon from a customer; and
means for integrating processing the payment and the coupon.
